(19) United States
(12) Patent Application Publication
(10) Pub. No.: US 2010/0094668 A1
(43) Pub. Date: Apr. 15, 2010

(54) SYSTEM AND METHOD FOR MAKING A RESERVATION ASSOCIATED WITH A CALENDAR APPOINTMENT

(75) Inventors: Shekhar Gupta, Overland Park, KS (US); Kelsyn D.S. Rooks, Overland Park, KS (US); Jeffrey Sweeney, Olathe, KS (US); Mark Wilmoth, Gardner, KS (US); Kendra Dwyer, Wellsville, KS (US)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: EMBARQ HOLDINGS COMPANY, LLC

(21) Appl. No.: 12/250,035

(22) Filed: Oct. 13, 2008

(51) Int. Cl. G06Q 10/00

(52) U.S. Cl. 705/5

(57) ABSTRACT

According to one embodiment of the invention, a method for making a reservation associated with a calendar appointment is presented. The method includes monitoring a calendar application for reservation type appointments. In response to identifying a reservation type appointment, the method determines whether a network reservation may be made with a service provider associated with the reservation type appointment. If a network reservation may be made with the service provider, the method automatically enters in information for making the network reservation with data retrieved from the reservation type appointment and submitting the network reservation to the service provider.

### BACKGROUND

1. Field of the Invention

The principles of the present invention relate to computers, and more specifically, to providing appointment notifications associated with a calendar appointment.

2. Description of the Related Art

With the advent of computers, many people have moved away from having physical calendars to using electronic calendars for keeping track of appointments and other important dates. Examples of electronic calendars include Microsoft® Outlook®, Google® Calendar™, and Yahoo!® Calendar™. Most electronic calendars allow a user to schedule appointments by selecting a time and date. In addition, some electronic calendars allow a user to specify a location associated with the appointment. Further, some electronic calendars provide pop-up reminders to a user of an upcoming appointment.

### SUMMARY

According to one embodiment of the invention, a method for making a reservation associated with a calendar appointment is presented. The method includes monitoring a calendar application for reservation type appointments. In response to identifying a reservation type appointment, the method determines whether a network reservation may be made with a service provider associated with the reservation type appointment. If a network reservation may be made with the service provider, the method automatically enters in information for making the network reservation with data retrieved from the reservation type appointment and submits the network reservation to the service provider.

### BRIEF DESCRIPTION OF THE DRAWINGS

For a more complete understanding of the present application, the objects and advantages thereof, reference is now made to the following descriptions taken in conjunction with the accompanying drawings, in which:

FIG. 1 depicts a network environment in which the illustrative embodiments may be implemented;

FIG. 1A depicts a local environment in which the illustrative embodiments may be implemented;

FIG. 2 is a high level component diagram of a data processing system in which the illustrative embodiments may be implemented;

FIG. 3 is an embodiment of a graphical user interface for entering a calendar appointment;

FIG. 4 is an embodiment of a virtual receptionist for making a reservation associated with a calendar appointment;

FIG. 5 is an embodiment of a process for making reservations in accordance with the disclosed embodiments;

FIG. 6 is another embodiment of a process for making a reservation associated with a reservation type appointment;

FIG. 7 is an embodiment of a process for monitoring for additional information following a sent request; and

FIG. 8 is an embodiment of a process for making a telephone reservation.

### DETAILED DESCRIPTION OF THE DRAWINGS

The disclosed embodiments provide a system and method for making reservations in response to identifying a reservation type appointment. A reservation type appointment, as referenced herein, is a calendar appointment that is associated with a service provider that permits reservations to be made to ensure availability of a service at a particular time. Examples of reservation type appointments include, but are not limited to, dinner appointments, business appointments, vehicle maintenance appointments, and doctor appointments.

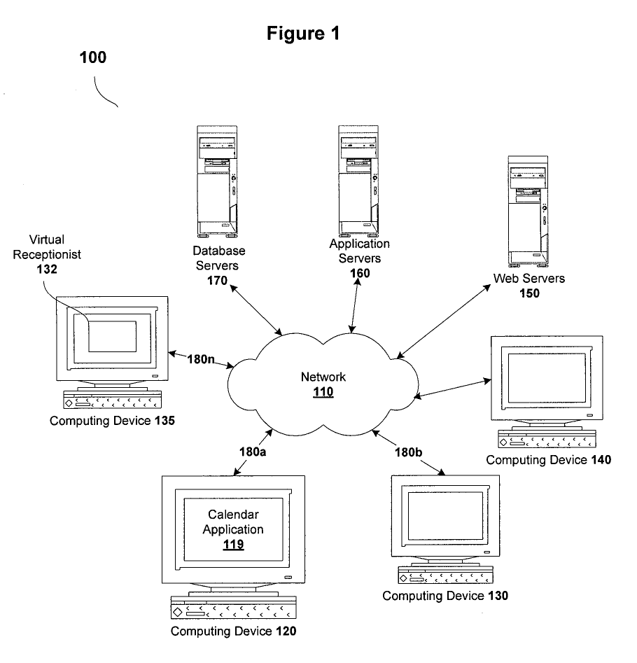

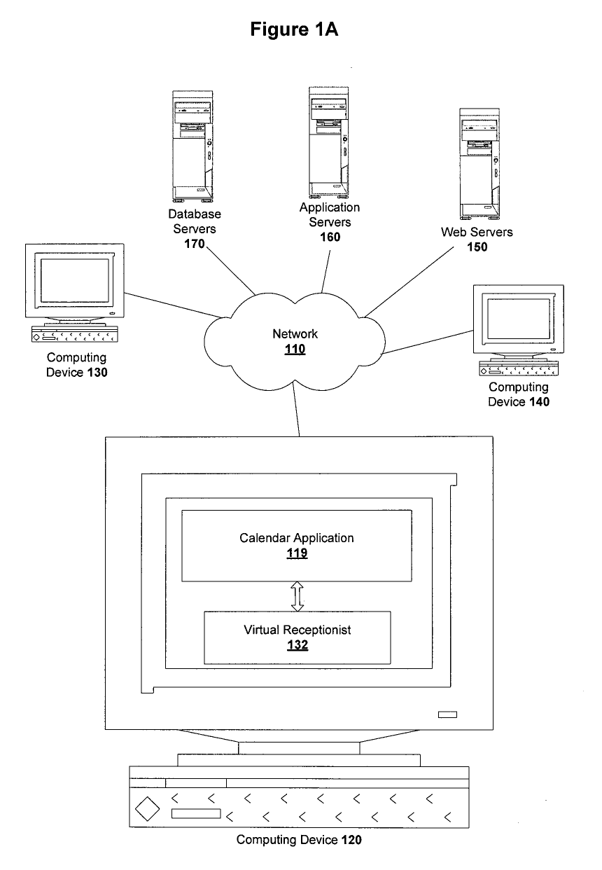

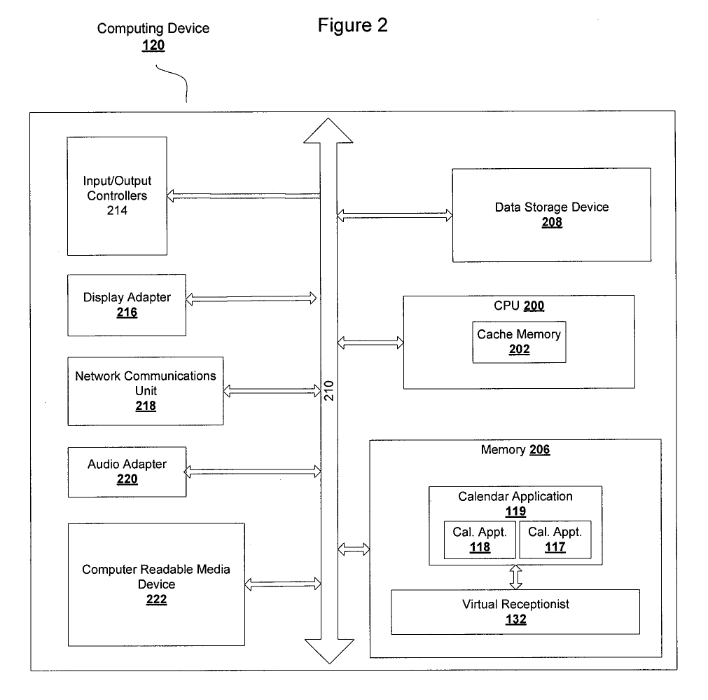

With reference now to the Figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a network environment 100 in which the illustrative embodiments may be implemented. Network environment 100 includes network 110, which is the medium used to provide communications links between various devices and computers, such as, but not limited to, computing device 120, computing device 130, computing device 135, computing device 140, web servers 150, application servers 160, and database servers 170 connected together within network environment 100. Network 110 may include connections 180a-180n, such as wire, wireless communication links, or fiber optic cables to each of the devices.

Web servers 150, application servers 160, and database servers 170 may include one or more servers, such as, but not limited to, IBM System p® servers. In addition, computing device 120, computing device 130, computing device 135, and computing device 140 may be, for example, personal computers, network computers, personal digital assistants (PDAs), and/or smart phones. In the depicted example, web servers 150, application servers 160, and database servers 170 provide data and/or services, such as, but not limited to, data files, operating system images, and applications to computing device 120, computing device 130, computing device 135, and computing device 140. Network environment 100 may include additional servers, clients, and other devices not shown.

In some embodiments, network 110 is the Internet. The Internet is a global system of interconnected computer networks that interchange data using the standardized Internet Protocol Suite (TCP/IP). The Internet includes millions of private and public networks that are linked by copper wires, fiber-optic cables, wireless connections, and other technologies. Of course, network 110 may also be implemented as a number of different types of networks, such as, but not limited to, an intranet, a local area network (LAN), or a wide area network (WAN).

The disclosed embodiments provide a virtual receptionist 132. Virtual receptionist 132 is a computer program that monitors a calendar application 119 associated with a user for providing an automated reservation process. As depicted in FIG. 1, in some embodiments, virtual receptionist 132 may reside on a computing device 135 remote from calendar application 119. In these embodiments, virtual receptionist 132 may request and receive appointment related information from calendar application 119. Alternatively, in some embodiments, calendar application 119 may routinely send appointment related information to virtual receptionist 132. Of course, virtual receptionist 132 may also reside on a server, such as, but not limited to, application servers 160. FIG. 1 is intended as an example, and not as an architectural limitation for the different illustrative embodiments. For example, in some embodiments, the calendar appointments associated with a user may be monitored by more than one virtual receptionists and/or one virtual receptionist may monitor calendar appointments associated with more than one user.

In addition, in some embodiments, virtual receptionist 132 may reside on the same computing device 120 as calendar application 119 as depicted in FIG. 1A. In some embodiments, virtual receptionist 132 may use an application programming interface (API) to retrieve appointment related data from calendar application 119. Alternatively, in some embodiments, virtual receptionist 132 may be incorporated as a part of calendar application 119 and/or vice versa. Further, in some embodiments, a user may be required to register the calendar appointments that the user desires to be monitored by a virtual receptionist.

FIG. 2 is an embodiment of computing device 120 in accordance with the embodiment depicted in FIG. 1A. In this embodiment, computing device 120 includes communications bus 210, which provides communications between central processing unit (CPU) 200, memory 206, data storage device 208, input/output (I/O) controllers 214, display adapter 216, network communications unit 218, audio adapter 220, and computer readable media device 222.

CPU 200 executes instructions for software that may be loaded into memory 206. CPU 200 may be a set of one or more processors or may be a multi-processor core, depending on the particular implementation. Further, CPU 200 may include one or more levels of cache memory, such as, but not limited to, cache memory 202. Cache memory 202 is used by CPU 200 to store copies of the data from the most frequently used main memory locations to reduce the average time to access memory.

Memory 206 is used to retain digital data used for processing. In some embodiments, memory 206 may be a random access memory (RAM). RAM memory allows the stored data to be accessed in any order as opposed to storage mechanisms, such as tapes and magnetic discs. In addition, memory 206 may include any other suitable volatile or non-volatile storage device.

CPU 200 loads computer executable instructions, such as, but not limited to, calendar application 119 into memory 206 for execution. Calendar application 119 may include one or more calendar appointments, such as, but not limited to, calendar appointment 117 and calendar appointment 118. In addition, CPU 200 may load computer executable instructions for virtual receptionist 132 into memory 206 for identifying reservation type calendar appointments associated with calendar application 119.

Data storage device 208 may take various forms depending on the particular implementation. For example, data storage device 208 may be a hard drive, flash memory, rewritable optical disk, rewritable magnetic tape, or some combination thereof. The media used by data storage device 208 also may be removable, such as, but not limited to, a removable hard drive.

Input/output unit 214 may include one or more of the same and/or different types of data ports used for connecting external devices to computing device 120. Input/output unit 214 may include a serial port, a parallel port, an accelerated graphics port, and most commonly a universal serial bus (USB) port. For example, input/output unit 214 may be used to connect computer peripherals, such as mice, keyboards, PDAs, gamepads and joysticks, scanners, digital cameras, printers, personal media players, and flash drives.

Display adapter 216 is used to generate and output images to a display. Display adapter 216 may be a dedicated expansion card that is plugged into a slot on the motherboard of computing device 120 or may a graphics controller integrated into the motherboard chipset. In addition, display adapter 216 may include dedicated memory and one or more processing units.

Network communications unit 218 provides for communications with other data processing systems or devices. In these examples, network communications unit 218 is a network interface card. Modems, cable modem, Ethernet cards, and wireless interface cards are just a few of the currently available types of network interface adapters. Network communications unit 218 may provide communications through the use of physical and/or wireless communications links.

Audio adapter 220 facilitates the input and output of audio signals to and from computing device 120. For example, audio adapter 220 may provide the audio component for multimedia applications, such as music composition, editing video or audio, presentation/education, and/or entertainment, such as video games. In some embodiments, audio adapter 220 may be an expansion card added to computing device 120 to provide for audio capability.

Computer readable media device 222 provides a mechanism for reading and writing to tangible forms of computer media, such as, but not limited to, a floppy disc, a compact disc (CD), a digital versatile disc (DVD), and memory cards. For example, CPU 200 may use computer readable media device 222 to read instructions stored on a computer media for executing the computer executable instructions of virtual receptionist 132.

The different components illustrated for computing device 120 are not meant to provide architectural limitations to the manner in which different embodiments may be implemented. For example, the different illustrative embodiments may be implemented in a data processing system including components in addition to or in place of those illustrated for computing device 120.

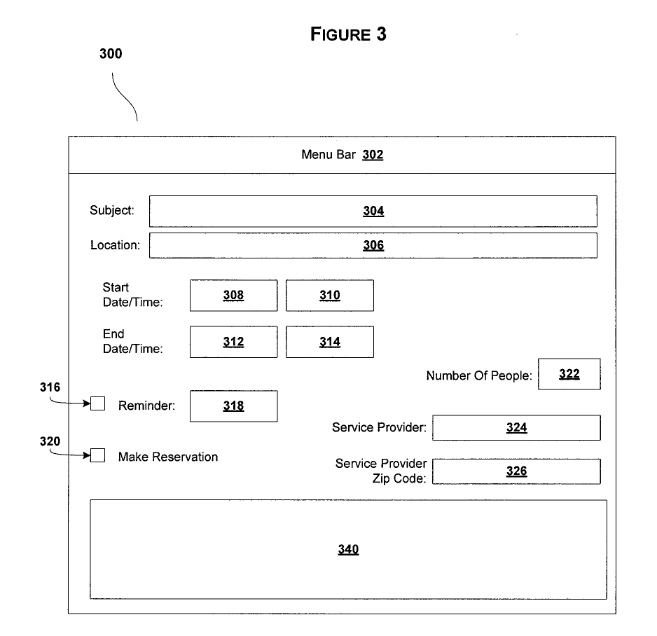

FIG. 3 is an embodiment of a graphical user interface 300 for entering a calendar appointment, such as, but not limited to, calendar appointment 118 as depicted in FIG. 2. In some embodiments, all data fields associated with graphical user interface 300 are required data entry fields. Alternatively, in some embodiments, certain data entry fields may remain empty.

Graphical user interface 300 includes a menu bar 302. Menu bar 302 may include one or features associated with creating a new calendar appointment. For example, menu bar 302 may include features for spellchecking, formatting, and/or saving a new calendar appointment.

In addition, graphical user interface 300 includes a subject data entry field 304 and a location data entry field 306. Subject data entry field 304 may be used to specify a subject/event associated with the calendar appointment. In addition, location data entry field 306 may be used to specify a location associated with calendar appointment. In some embodiments, if a user enters a physical address in location data entry field 306, virtual receptionist 132 may retrieve information relating to the physical address, such as, but not limited to, the name and contact information of a service provider associated with the specified location. The information may be retrieved from a database associated with virtual receptionist 132 and/or virtual receptionist 132 may attempt to retrieve the information over network 110.

Graphical user interface 300 may also include a start date data entry field 308 and a start time data entry field 310 for selecting a start date and time associated with a calendar appointment. In some embodiments, start date data entry field 308 and start time data entry field 310 may be a pull down menu of dates and times to allow a user to select a desired date and time. Similarly, in some embodiments, graphical user interface 300 includes an end date data entry field 312 and an end time data entry field 314.

Additionally, in some embodiments, graphical user interface 300 may allow a user to select a reminder option 316 for providing the user with reminders of the created calendar appointment. For example, a user may specify in reminder data entry field 318 that a reminder be sent to the user 15 minutes prior to the specified start date and time.

In some embodiments, graphical user interface 300 may include a make reservation option 320. In these embodiments, if a user selects make reservation option 320, graphical user interface 300 may enable one or more data fields for gathering additional information relating to the desired reservation, such as, but not limited to, number of people data field 322, name of service provider data field 324, and service provider zip code data field 326.

Additionally, in some embodiments, additional notes/text may be associated with the calendar appointment in data entry field 340. For example, a user may enter a reservation request note, such as, “Please, reserve a table with a view of the ocean.”

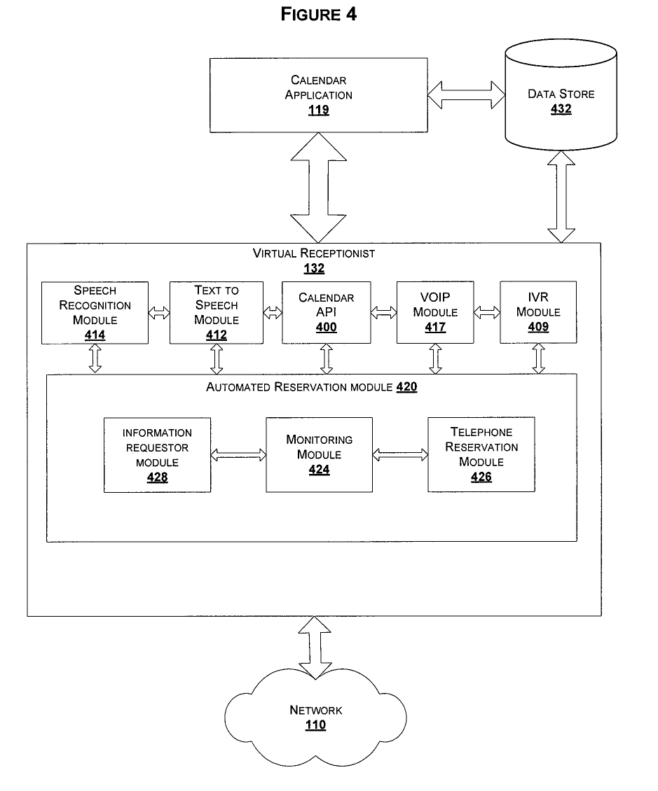

FIG. 4 is an embodiment of a virtual receptionist for providing an automated reservation process. Virtual receptionist 132 includes, among other modules, a calendar application programing interface (API) 400, IVR module 409, text to speech module 412, speech recognition module 414, VOIP module 417, and automated reservation module 420.

Calendar API 400 is a set of functions, procedures or classes used for accessing and retrieving appointment related data from calendar application 119. In some embodiments, calendar API 400 may be implemented as part of calendar application 119. For example, Google® Calendar™ Data API may be used to create new calendar appointments, edit or delete existing calendar appointments, and query for calendar appointments that match particular criteria.

IVR module 409 provides interactive voice response technology for automating interactions with a person over a telephone. IVR module 409 provides recorded voice prompts and menus to present information and options to a caller. A user may respond to the presented options by selecting an option using a touch-tone telephone keypad. IVR module 409 interprets the user-initiated responses to the presented options.

In some embodiments, text to speech module 412 enables IVR module 409 to present a non-prerecorded message to a person. For instance, in some embodiments, in making an automated reservation, virtual receptionist 132 may read text from data entry field 340 as depicted in FIG. 3. For example, virtual receptionist 132 may say, “Mr. Smith has the following request ‘please reserve a table with a view of the ocean.” Further, in some embodiments, speech recognition module 414 enables input and responses to be gathered via spoken words using voice recognition.

VOIP module 417 enables virtual receptionist 132 to communicate voice over the Internet and/or other data networks. In some embodiments, VOIP module 417 may transmit more than one telephone call at a time over the same broadband connection. Further, in some embodiments, VOIP module 417 secures the voice communication by encrypting the data stream.

Automated reservation module 420 monitors a calendar application, such as calendar application 119 for reservation type appointments using a monitoring module 424. In some embodiments, automated reservation module 420 may also include a telephone reservation module 426 and an information requestor module 428.

As will be further described, in response to identifying a reservation type appointment, monitoring module 424 determines whether a network reservation may be made with a service provider associated with the reservation type appointment. A network reservation is a reservation that may be made by communicating data between various data processing systems over a network, such as, but not limited to, the Internet. If a network reservation may be made with the service provider, monitoring module 424 automatically enters in information for making the network reservation with data retrieved from the reservation type appointment and submits the network reservation to the service provider.

In some embodiments, information requestor module 428 may request additional information needed by monitoring module 424 to either identify a calendar appointment and/or to retrieve additional information needed in making a reservation. For example, in some embodiments, information requestor module 428 sends the user an email requesting the additional information. Additionally, in some embodiments, information requestor module 428 monitors for a response from the user and notifies monitoring module 424 when the data is received. Further, in some embodiments, information requestor module 428 may submit follow-up requests to the user if the requested information is not received within a specified period of time.

In some embodiments, monitoring module 424 executes telephone reservation module 426 in response to a determination that a network reservation may not be made with a service provider associated with an identified reservation type calendar appointment. As will be further described, in some embodiments, telephone reservation module 426 generates a script and calls the service provider, using VOIP module 417, to request the service provider make the desired reservation associated with the identified reservation type calendar appointment.

In addition, in some embodiments, virtual receptionist 132 stores and retrieves data from a data store, such as, but not limited to, data store 432. Data store 432 may include of one or more local or remote databases. In some embodiments, data store 432 may include personal data associated with the user, such as, but not limited to, the user name, home address, phone number, work address, email address, credit card information, and/or other user-specified preferences (e.g., non-smoking preferred). For example, in making a reservation, virtual receptionist 132 may retrieve information, such as, but not limited to, a user's phone number to provide to a service provider as part of the reservation making process. Further, in some embodiments, data store 432 may include contact information associated with a service provider. For instance, a user may populate data store 432 with contact information, such as, but not limited to, phone numbers, email address, website address, and business hours associated with a plurality of service providers, such as, but not limited to, physicians, auto-shops, favorite restaurants, preferred hotels, etc. . . . As previously described above in FIG. 3, in entering a location for the reservation using graphical user interface 300, information from data store 432 and/or a network database (not shown) may be accessed and used to retrieve additional information relating to the specified location in location data entry field 306, such as, but not limited to, the name and contact information of a service provider associated with the specified location.

The embodiment of virtual receptionist 132 as disclosed in FIG. 4 is not intended to imply a particular implementation or limitation. Virtual receptionist 132 may include other components not illustrated or described above. Further, in some embodiments, the components/functions as depicted in FIG. 4 may be combined and/or omitted. For example, in some embodiments, if virtual receptionist 132 is incorporated as a part of calendar application 119 and/or vice versa, Calendar API 400 may be omitted.

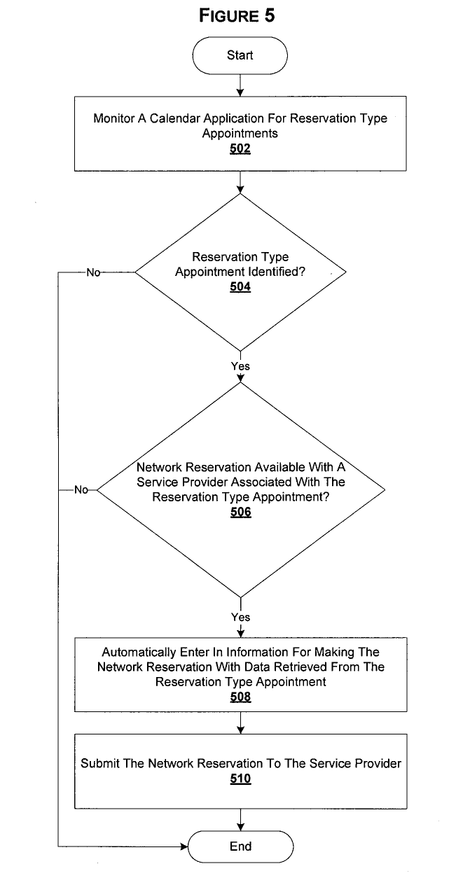

With reference now to FIG. 5, an embodiment of a process 500 for making reservations is presented. Process 500 begins by monitoring a calendar application for reservation type appointments at step 502. At step 504, the process determines if a reservation type appointment is identified. In response to identifying a reservation type appointment, the process, at step 506, determines whether a network reservation may be made with a service provider associated with the reservation type appointment. If the process determines that a network reservation may be made with the service provider associated with the reservation type appointment, the process automatically enters in information for making the network reservation with data retrieved from the reservation type appointment at step 508. The process submits the network reservation to the service provider at step 510, with the process terminating thereafter.

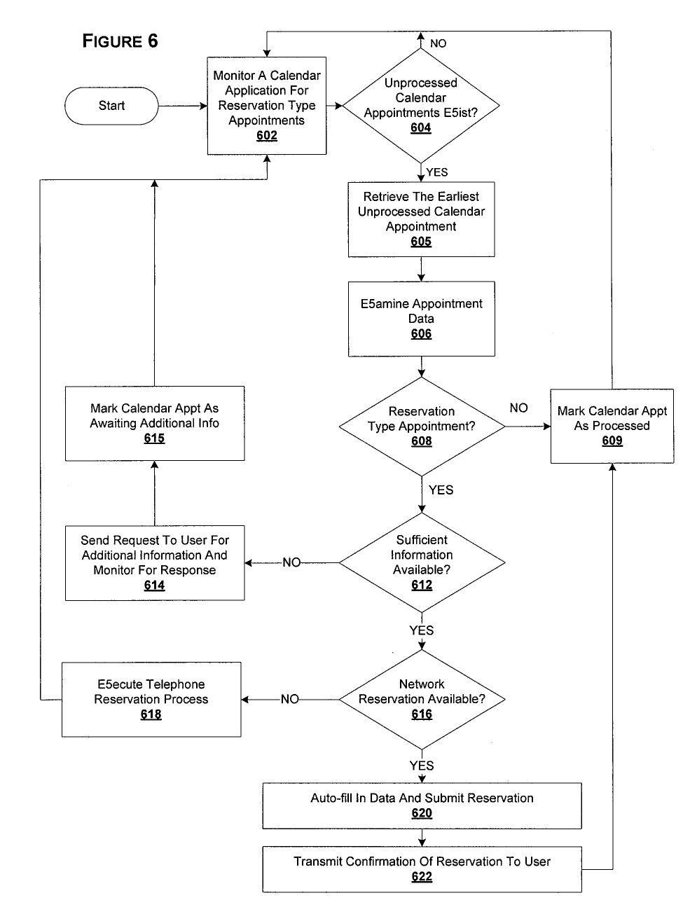

FIG. 6 is another embodiment of a process for making a reservation associated with a reservation type appointment. Process 600 begins by monitoring a calendar application for reservation type appointments at step 602. At step 604, the process determines whether any unprocessed calendar appointments associated with the calendar application exist. An unprocessed calendar appointment is a calendar appointment that has not been examined to determine whether the calendar appointment is a reservation type appointment. If at least one unprocessed calendar appointment associated with the calendar application exists, the process retrieves the earliest unprocessed calendar appointment at step 605. The process examines the appointment data at step 606. For example, in some embodiments, the process may perform a keyword search of the data associated with the retrieved calendar appointment for terms regularly associated with reservation type appointments, such as, but not limited to, doctor/dental appointments and restaurant reservations. In addition, in some embodiments, the process examines whether a user has identified the retrieved calendar appointment as a reservation type appointment by selecting a make reservation option, such as, but not limited to, selecting make reservation option 320 of graphical user interface 300. At step the 608, the process determines if the retrieved calendar appointment is a reservation type appointment. If the retrieved calendar appointment is not a reservation type appointment, the process marks the calendar appointment as process or indicates in some other manner that the calendar appointment has been examined at step 609. The process then returns to step 602.

However, if the retrieved calendar appointment is a reservation type appointment, the process determines whether sufficient information is available for making a reservation associated with the reservation type appointment at step 612. For example, a user may have identified the retrieved calendar appointment as a reservation type appointment, but did not specify the number of people associated with the reservation type appointment. If the process requires additional information, the process submits a request to the user for the desired information at step 614 and monitors for a response from the user. The process, at step 615, marks the retrieved calendar appointment as awaiting additional information. The process then returns to step 602.

If additional information is not needed, the process, at step 616, determines whether a network reservation may be made with the service provider associated with the retrieved calendar appointment. For example, in some embodiments, the process may query a database of service providers that provide a means for making a network reservation. Alternatively, in some embodiments, the process may query an Internet search engine to determine whether a network reservation may be made with the service provider. Further, in some embodiments, the process may determine if a network reservation may be made with the service provider via an Internet Website, such as, but not limited to, opentable.com®, hotels.com®, and travelocity.com®.

If the process determines that a network reservation may be made with the service provider associated with the retrieved calendar appointment at step 616, the process automatically enters in the information for making the network reservation with data retrieved from the reservation type appointment and submits the network reservation to the service provider at step 620. Alternatively, in some embodiments, prior to submitting the network reservation, process 600 may request authorization/permission from a user associated with the calendar application to proceed with scheduling the reservation. Further, in some embodiments, the process transmits a confirmation message of the reservation to the user at step 622. The confirmation message may be in the form of, but not limited to, an e-mail and/or a text message. At step 609, the process marks the retrieved calendar appointment as processed and/or indicates in some other manner that the calendar appointment has been examined. In some embodiments, if, at step 616, the process determines that a network reservation is unavailable, the process, as will be further described, executes a telephone reservation process at step 618 for making the reservation associated with the retrieved calendar appointment.

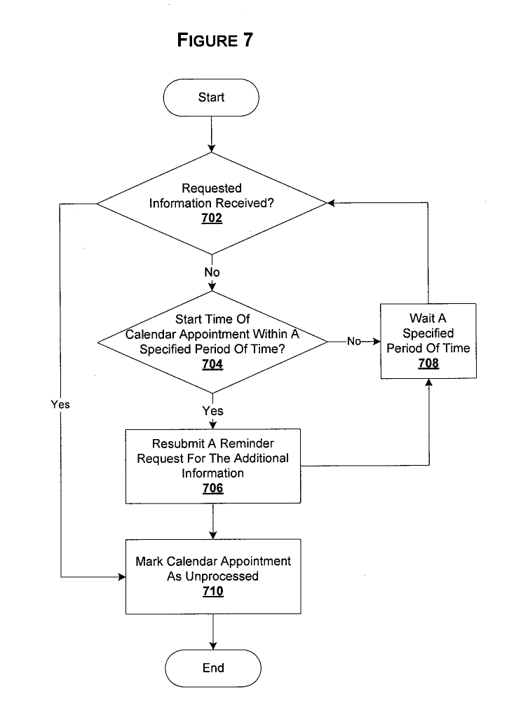

FIG. 7 is an embodiment of a process 700 for monitoring for additional information following a sent request at step 614. Process 700 begins by determining whether the additional requested information has been received at step 702. If the user has not provided the additional requested information, the process determines whether the start time of a calendar appointment associated with the sent request is within a specified period of time at step 704. If the start time of the calendar appointment is within a specified period of time, then the process may resubmit a reminder request for the additional information at step 706. For example, if the start time of the calendar appointment is less than 24 hours, the process may resend the user an e-mail reminder request. However, if the start time of the calendar appointment is not within a specified period of time, the process waits a specified period of time at step 708 before returning step 702. If at step 702, the process determines that the user has provided the requested information, the process marks the associated calendar appointment as unprocessed and/or indicate in some other manner that the calendar appointment needs to be examined at step 710, with the process terminating thereafter.

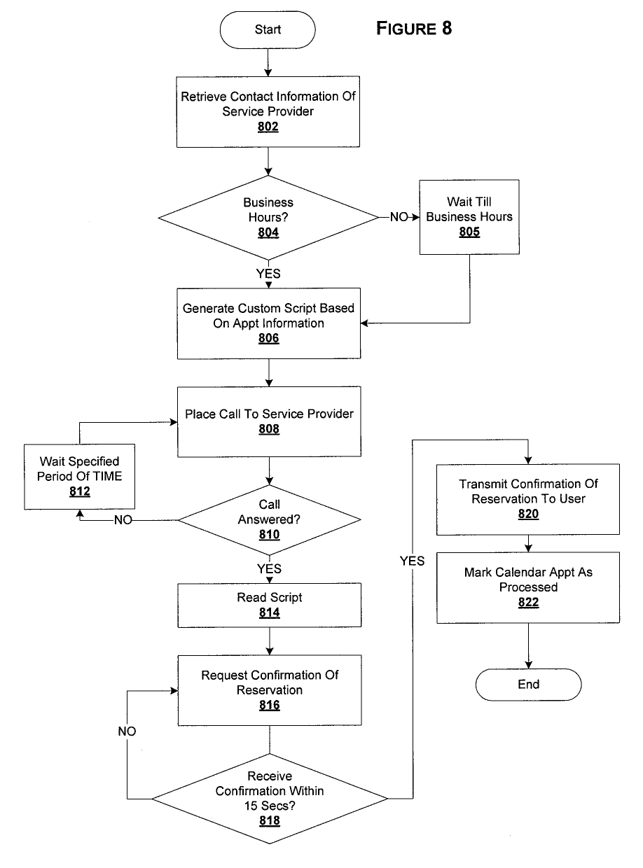

FIG. 8 is an embodiment of a process 800 for making a telephone reservation. Process 800 begins by retrieving the contact information for the service provider associated with the retrieved calendar appointment at step 802. For example, the process may retrieve a phone number and business hours associated with the service provider from data store 432 or from a source located on the Internet. The process, at step 804, determines if the current time is within the business hours of the service provider accounting for the time zone if the location is outside the user's time zone. If the current time is not within the business hours of the service provider, the process, at step 805, waits until the current time is within the business hours of the service provider associated with the retrieved calendar appointment.

If and/or when the current time is within the business hours of the service provider, the process generates a custom script based on the data associated with the retrieved calendar appointment at step 806. For example, the custom script may include the name of the service provider, the name of the user, contact information of the user, a requested time for the reservation, and/or a number of people associated with the reservation. The process then places a call to the service provider at step 808. At step 810, the process determines whether the call has been answered by a live person. For example, the process may determine that the phone has been answered by a live person if a brief message is heard from the other end followed by a pause, such as an employee answering the phone saying “hello” and/or providing a short greeting. However, if a continuous message is heard, then the process may determine that an answering machine answered the call. If, at step 810, the process determines that the call has not been answered by a live person, the process, at step 812, waits a specified period of time prior to re-calling the service provider at step 808.

If the process determines that a live person has answered the call at step 810, the process, using text-to-speech technology, reads the custom script to the person answering the call at step 814. Alternatively, in some embodiments, the process may play a recorded message instead of reading the custom script. Further, in some embodiments, the process may request that the person answering the call to confirm the reservation at step 816. For example, the process may request that the person answering the call enter the # key to confirm that a reservation has been made. Moreover, in some embodiments, if, at step 818, the process does not receive confirmation within a specified period of time, e.g., 15 seconds, the process may return to step 816 to re-request confirmation of the reservation. In some embodiments, the process may present an option to the person answering the call to replay the script. If confirmation is received, the process transmits a confirmation message to the user that the reservation associated with the retrieved calendar appointment has been made at step 820. The process marks the retrieved calendar appointment as having been processed at step 822, with process terminating thereafter.

Accordingly, the disclosed embodiments provide a system and method for making automated reservations in response to identifying a reservation type appointment associated with a calendar application. Further, in some embodiments, if a network reservation may not be made with a service provider, the disclosed embodiments provide a method for calling the service provider and requesting the desired reservation.

As will be appreciated by one skilled in the art, the disclosed embodiments may be embodied as a system, method, or computer program product. Accordingly, the disclosed embodiments may be implemented entirely with hardware or as a software embodiment (including firmware, resident software, micro-code, etc.) or an embodiment combining software and hardware aspects that may all generally be referred to herein as a “circuit,” “module” or “system.” Furthermore, the disclosed embodiments may take the form of a computer program product embodied in any tangible medium of expression having computer-usable program code embodied in the medium.

Computer program code for carrying out operations of the present invention may be written in any combination of one or more programming languages, including an object oriented programming language, such as Java, Smalltalk, C++, or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The disclosed embodiments described above with reference to flowchart illustrations and/or block diagrams. Each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” and/or “comprising,” when used in this specification and/or the claims, specify the presence of stated features, integers, steps, operations, elements, and/or components, but do not preclude the presence or addition of one or more other features, integers, steps, operations, elements, components, and/or groups thereof. The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

In addition, the flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which may include one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed:

1. A method for making reservations, the method comprising:
monitoring a calendar application for reservation type appointments;
responsive to identifying a reservation type appointment, determining whether a network reservation may be made with a service provider associated with the reservation type appointment;
responsive to a determination that a network reservation may be made with the service provider, automatically entering in information for making the network reservation with data retrieved from the reservation type appointment; and
submitting the network reservation to the service provider.

2. The method of claim 1, further comprising transmitting a reservation confirmation message to a user associated with the calendar application.

3. The method of claim 1, further comprising requesting missing information associated with the reservation type appointment from a user associated with the calendar application.

4. The method of claim 1, wherein identifying a reservation type appointment further comprises identifying key terms normally associated with a reservation type appointment.

5. The method of claim 1, wherein identifying a reservation type appointment further comprises identifying whether a calendar appointment has been designated as a reservation type appointment by a user associated with the calendar application.

6. The method of claim 1, further comprising requesting authorization from a user associated with the calendar application prior to submitting the network reservation.

7. The method of claim 1, further comprising retrieving user preferences for making the network reservation from a data store.

8. The method of claim 1, further comprising:
subsequent to a determination that a network reservation may not be made with the service provider, calling the service provider over a data network; and
requesting the service provider make a reservation associated with the reservation type appointment in response to the service provider answering the call.

9. The method of claim 8, further comprising:
generating a custom script with information associated with the reservation type appointment; and
reading the custom script to the service provider.

10. The method of claim 8, further comprising requesting the service provider provide a confirmation of the reservation.

11. The method of claim 10, further comprising transmitting a reservation confirmation message to a user associated with the calendar application in response to receiving the confirmation from the service provider.

12. A system for providing appointment notifications, the system comprising:
a data bus system;
memory coupled to the data bus system, the memory including computer usable program code;
a network communication device coupled to the data bus for sending and receiving data;
a processing unit coupled to the data bus system, the processing unit executing the computer usable program code to:
monitor a calendar application for reservation type appointments;
identify a reservation type appointment;
determine whether a network reservation may be made with a service provider associated with the reservation type appointment;
automatically enter in information for making the network reservation with data retrieved from the reservation type appointment; and
submit the network reservation to the service provider.

13. The system of claim 12, wherein the processing unit further executes the computer usable program code to transmit a reservation confirmation message to a user associated with the calendar application.

14. The system of claim 12, wherein the processing unit further executes the computer usable program code to request additional information associated with the reservation type appointment from a user associated with the calendar application.

15. The system of claim 12, wherein the processing unit further executes the computer usable program code to identify whether a calendar appointment has been designated as a reservation type appointment by a user associated with the calendar application

16. The system of claim 12, wherein the processing unit further executes the computer usable program code to request authorization from a user associated with the calendar application prior to submitting the network reservation.

17. The system of claim 12, wherein the processing unit further executes the computer usable program code to retrieve user preferences for making the network reservation from a data store.

18. The system of claim 12, wherein the processing unit further executes the computer usable program code to:
call the service provider over a data network subsequent to a determination that a network reservation may not be made with the service provider, and
request the service provider to make a reservation associated with the reservation type appointment.

19. The system of claim 18, wherein the processing unit further executes the computer usable program code to:
generate a script with information associated with the reservation type appointment; and
present the script to the service provider.

20. The system of claim 18, wherein the processing unit further executes the computer usable program code to:
request the service provider provide a confirmation of the reservation.
